(19) United States
(12) Patent Application Publication
(10) Pub. No.: US 2019/0050501 A1
(43) Pub. Date: Feb. 14, 2019

(54) COMPUTER ARCHITECTURE FOR PREDICTIVE MODELING OF DETERIORATION OF INDIVIDUAL COMPONENTS USING HETEROGENEOUS INSPECTION RECORDS

(71) Applicant: United States of America as Represented by The Secretary of The Army, Alexandria, VA (US)

(72) Inventor: Michael N. Grussing, Champaign, IL (US)

(21) Appl. No.: 15/674,321

(22) Filed: Aug. 10, 2017

(51) Int. Cl. G06F 17/50; G06N 5/02; G06F 17/30

(52) U.S. Cl. CPC G06F 17/5004; G06F 17/30979; G06N 5/022

(57) ABSTRACT

This invention provides a system for predicting deterioration of a specific building component using novel Component-in-Service (CIS) objects. The system receives heterogeneous inspection data records produced at irregular time intervals. The system normalizes inspection dates obtained from actual observation of each component over time and continuously revises a novel Predictive Component Deterioration Model Object The Predictive Component Deterioration Model Object is a single predictive model produced by extracting corresponding actual inspection data from multiple CIS Objects for normalized time intervals.

### STATEMENT REREGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### FIELD OF INVENTION

This invention'relates to the field of computer processing architecture and more specifically to a specialized computer architecture for modeling deterioration and predicting the optimal replacement date for each individual building component-in-service within a large, geographically disbursed building portfolio.

### BACKGROUND OF THE INVENTION

The U.S. government maintains a real estate portfolio valued in excess of $300 billion. Budding expenditures are the second largest outlay for the federal government.

The federal government portfolio spans 900,000 buildings while, state and local governments maintain an estimated additional 200,000 buildings. Over a billion components must be monitored for risk of failure. It is desirable to manage risk by avoiding costly premature replacement of components which have a remaining useful life and minimize resources necessary for on-site inspections.

BUILDER™ is a proprietary system developed by the U.S. Army Corps of Engineers (USACE) for advanced data gathering by scientists and engineers to reuse resources required for onsite inspections and to optimize useful life of assets.

In its current state, BUILDER™ is a repository of inspection data reported using a standardized condition index used to predict the life expectancy of each building component. Builder receives indexed inspection data from skilled facility inspectors. Inspection records indicate the date of inspection and a condition index rating. The standardized condition index rating is based on identified criteria applied onsite by inspectors trained in the technology.

BUILDER™ produces statistical models for individual components-in-service which can accurately predict component deterioration based on available data and facilitate a just-in-time component replacement to effectively balance the risk of component failure and the need to extend the economic life of assets.

BUILDER™ has been identified as Department of Defense priority necessary. BUILDER™ is currently in use or under study by the Marine Corps, Navy, Air Force, Defense Logistics Agency, Army, Defense Health Agency, Defense Commissary Agency National Nuclear Security Administration, and can be used to accommodate state and local governments and private sector use. As more historical data is gathered in standardized format, predictive capabilities are expected to increase.

The system has the capability to receive and process data from an unlimited quantity of component service data from an increasing number of agencies. This not only results in an efficient cost-sharing arrangement; it increases the accuracy of predictive models without substantially increasing the overhead associated, with processing the data.

It is a problem known in the art that component inspection data may be gathered at irregular inspections intervals. Furthermore, the inspection data may be collected in heterogeneous formats by the various agencies involved.

There is an unmet need for a standardized computer architecture, with normalization capabilities that can produce accurate statistical models from inspection data records having heterogeneous inspection formats and produced at irregular inspection intervals.

### BRIEF DESCRIPTION OF DRAWINGS

FIG. 1 illustrates an exemplary computer system for modeling component deterioration.

FIG. 2 illustrates an exemplary method for creating a model of predictive deterioration for a component over progressive normalized intervals.

FIGS. 3A and 3B illustrate exemplary processes performed by a Transition Tracking Object using a novel Transition Frequency Matrix.

FIG. 4 illustrates an exemplary process performed by a Predictive Component Deterioration Model (PCOM) Object for simulating condition estate progression over time.

### TERMS OF ART

As used herein, the term “actual” means observed or existing and includes data from actual inspections or testing of condition state.

As used herein, the term “actual observed condition” means a determination of component condition based on current and/or physical observation at a specific time.

As used herein, the term “associated” means correlated or related.

As used herein, the term “component-in-service” means any item placed in service in association with a budding or other resource for performing a specific functional task.

As used herein, the term “computer architecture” means an integrated set of processing components which define the specialized functionality of a computer apparatus or network. Computer architecture may refer hardware components, servers, data structures, class and object definitions, virtualized components and/or components stored in memory which are non-modifiable at run time to emulate physical hardware components and combinations thereof.

As used herein, the term “condition index value” means an indexed value reflecting component condition ascertained by an inspection on an inspection date.

As used herein the term “condition state” refers to a pair of condition index values corresponding to a first inspection date and a second inspection date which defines a time interval.

As used, herein, the term “condition state pair” means a data pair of two different condition index values corresponding to each of two different inspection date values.

As used herein, the term “condition state progression” means a data set associated with a component which includes condition index values for a component obtained for a sequence of inspections.

As used herein, the term “data structure” is any data in any format which can be stored in a computer and which may include non-modifiable attributes and values once created.

As used herein, the term “filtered” means having a like attribute created.

As used herein, the term “instantiate” means the creation of an instance of a processing component, class, object or other data structure.

As used herein, the term “invoke” means to initiate or call a function or an operation which causes a physical change or transformation.

As, used herein, the term “model” means a digital representation of phenomena which includes that which may be updated continuously, sporadically or in real time.

As used herein, the term “predicted condition state” means a probability of a condition state for a specific component for a specific time interval.

As used herein, the term “processor” means hardware or software having processing capability which may be bound to non-modifiable values and functions and which may include virtual components.

As used herein, the term “quasi-unique” means a value or attribute that is unique to are identifiable set of values and attributes or which may vary based on characteristics of each item or element within the set.

As used herein, the term “real time” means during a user session or any period allocated for study and analysis.

As used herein, the term “time interval” means a uniform time interval selected by a user and need not conform to the time to the variable observation interval. A time interval may or may not be normalized.

As used herein the term “Transition Frequency Matrix” means any data structure for representing known and/or expected component condition changes over a given period.

As used herein he term “virtual processing component” or “object” refers to a processing component which binds to a microprocessor at run time to functions identically to the circuitry of a physical processor.

### DETAILED DESCRIPTION OF THE INVENTION

The following description of exemplary embodiments of a [invention] shall be interpreted with reference to U.S. Supreme Court standards pertaining to computer implemented inventions. Functional processing components may be described in terms of hardware or software processing (“virtual”) components. The term “apparatus” may refer to one or multiple devices and may contain virtual components functionally integrated with hardware to perform novel or specialized processing functions. Furthermore, various types of virtual components may be referred to as “classes” or “objects,” however this designation shall not be construed as language or platform specific. A class, object or virtual component may refer to any aggregation of functions and data types which may be functionally bound to a microprocessor to form a specific purpose computer with novel and identifiable capabilities.

The terms “a” and “an” may refer to a single or multiple elements of the same type and shall be interpreted as “at least one.” The term “plurality” shall mean two or more. Steps may be performed in any order and shall be construed to encompass any function, formula, process or transformative action.

References to data types and data sets (e.g., attributes, parameters and variables) shall be interpreted as data sets derived through experimentation to yield specific or unexpected results. Tables may be identified as representing data structures, arrays or the like.

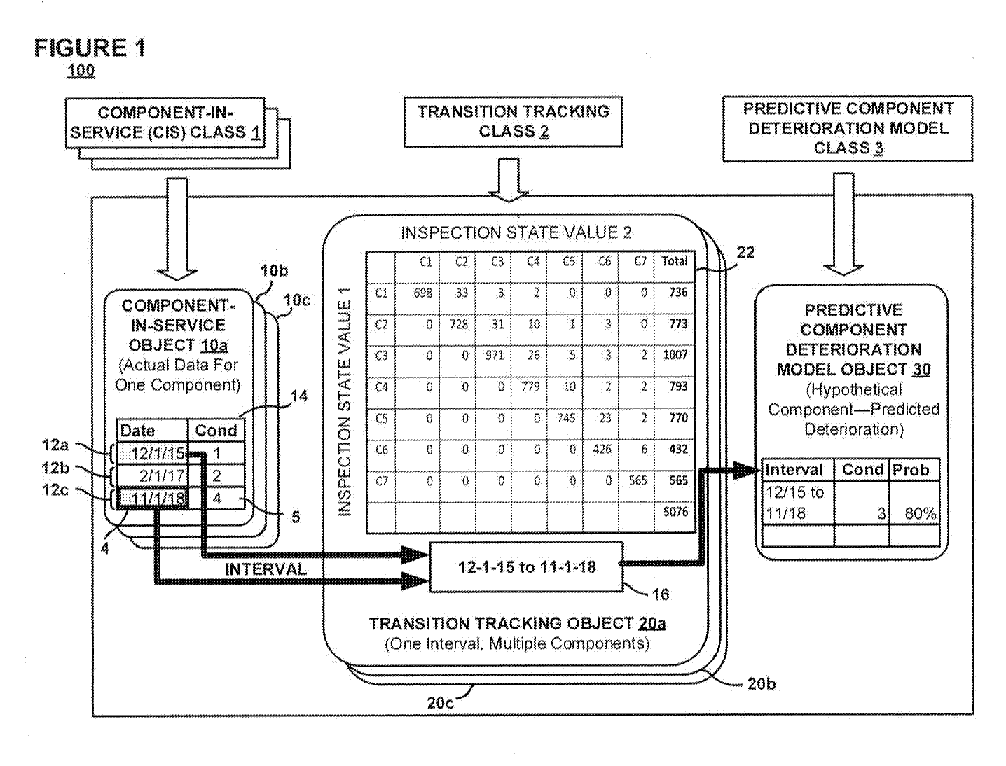

FIG. 1 illustrates an exemplary System 100 for modeling component deterioration. In the exemplary embodiment shown, System 100 has a computer architecture which includes virtual processing components for predictively modeling the deterioration of an individual component-in-service (CIS) The model may be generated by the System 100 based, at least in part, on a user selected observation time interval 16 and a statistical prediction based on historical data from a plurality of components taken over he same time intervals.

In the exemplary embodiment shown, System 100 includes three virtual processors or classes, which instantiate objects including: a Component-In-Service (CIS) Class 1, a Transition Tracking Class 2 and a Predictive Component Deterioration Model Class 3.

Component-in-Service Class 1 is a virtual processor which instantiates a plurality of Component-In-Service (CIS) Objects 10a, 10b, 10c. Each CIS Object tracks actual inspection data as observed and processed into actual inspection data records 12a, 12b and 12c. Each actual inspection data record 12a, 12b and 12c are comprised of two data values: an inspection date value 4 and a condition index value 5. The condition index value 5 can be any numerical condition index known in the art or developed, such as the following:

| | | MID | |
|---|---|---|---|
| CONDITION | CONDITION | RANGE | |
| STATE | RANGE | VALUE | DESCRIPTION |
| C1 | >99 | 100 | G+ rating; Minimal to no condition loss |
| C2 | 99-92 | 95 | G rating: Slight condition loss |
| C3 | 92-85 | 88 | G− rating; Minor Condition loss |
| C4 | 85-75 | 80 | A+ rating; Noticeable Condition loss |
| C5 | 75-65 | 71 | A rating; Significant condition loss |
| C6 | 65-50 | 61 | A− rating: Major condition loss |
| C7 | <=50 | 30 | R rating; Severe condition loss; at or near |
| | | | failure |

Each inspection data record 12a, 12b and 12c is stored sequentially in a data structure referred to as an Inspection Data Matrix 14. Each of the CIS Objects 10a, 10b, 10c include an Inspection Data Matrix 14, which is a listing of inspection dates and actual observed conditions. The inspection dates may be conducted at irregular intervals.

Each CIS Object 10a, 10b and 10c is configured to receive a user elected time interval 16. The user selected time interval 16 identifies a sequence of two dates which fall within the range of dates identified in the Inspection Data Matrix 14. In the exemplary embodiment shown, the first of two inspection date values is Dec. 1, 2015 corresponding to inspection data record 12a while the second Nov. 1, 2018 corresponding to inspection data record 12c. Also, each inspection date value corresponds to a condition index value. For example, inspection date value 4 (a value of Nov. 1, 2018) of inspection data record 12c corresponds to a condition index value 5 (a value of 4).

A user may select any two dates within the Inspection Data Matrix 14 for specifying a time interval 16. The user-selected time interval 16is applied by System 100 to extract data for the same period of like-kind s, i,e., those having similar attributes for the same time interval 16. Exemplary attributes of like-kind components are depicted in tabular form below:

| | Component Identifier | | |
|---|---|---|---|
| | 783273 | 384832 | 954957 |
| Region | Mid-Atlantic | Mid-Atlantic | Mid-Atlantic |
| Building | 124 | 325 | 675 |
| Number | | | |
| Building Type | ADMIN | COMPANY HQ | WAREHOUSE |
| System | D30 HVAC | D30 HVAC | D30 HVAC |
| Sub-System | D3050 | D3050 | D3050 |
| | TERMINAL & | TERMINAL & | TERMINAL & |
| | PACKAGE | PACKAGE | PACKAGE |
| | UNITS | UNITS | UNITS |
| Component | D3050175- | D3050175- | D3050175- |
| Type | Rooftop A/C | Rooftop A/C | Rooftop A/C |
| Description | ROOF TOP | ROOF TOP | ROOF TOP |
| | UNIT, SINGLE | UNIT, SINGLE | UNIT, SINGLE |
| | ZONE | ZONE | ZONE |
| Quantity/Units | 2 EA | 1 EA | 4 EA |
| Year Installed | 1990 | 1984 | 2001 |

Each column of the table above corresponds to a different component while each row corresponds to a specific component attribute of said component. In this example, the components are air conditioning units (e.g., Component Type D3050175—Rooftop A/C), thus of like-kind. Multiple actual inspection data records 12a, 12b and 12c may be associated with a single set of component attributes (e.g., one column) and, each CIS Object 10a, 10b and 10c it stance may correspond to respective like-kind component.

In one embodiment, System 100 includes a Transition Tracking Class 2 which instantiates a Transition Tracking (TT) Object 20a, 20b and 20c in,association with the user selected time interval 16. For example, the time interval 16 corresponds to a period ranging from a first inspection date value to a second inspection date value of inspection state records 12a and 12c respectively. In an exemplary embodiment, the TT Objects 20a, 20b and 20c generate a corresponding Transition Frequency Matrix 22 for specifying a frequency of transition of multiple components from one condition to another for the one user specified time interval 16. The TT Objects 20a, 20b and 20c normalize the time interval 16 accordingly across each component instance's pair of inspections, thus ensuring accurate filtering of the actual observed inspection data across disparate components for the selected time interval 16.

The Transition Frequency Matrix 22 includes a plurality of cells, wherein a first range of columns representing a change in condition index values from lowest to highest (e.g., condition index values C1 to C7) is labeled Inspection State Value 2. The corresponding rows of the Transition Frequency Matrix 22 also correspond to a change in condition index value from lowest to highest, labeled as Inspection State Value 1. Thus, each cell corresponds to two coordinates reflecting a quasi-unique condition state pair.

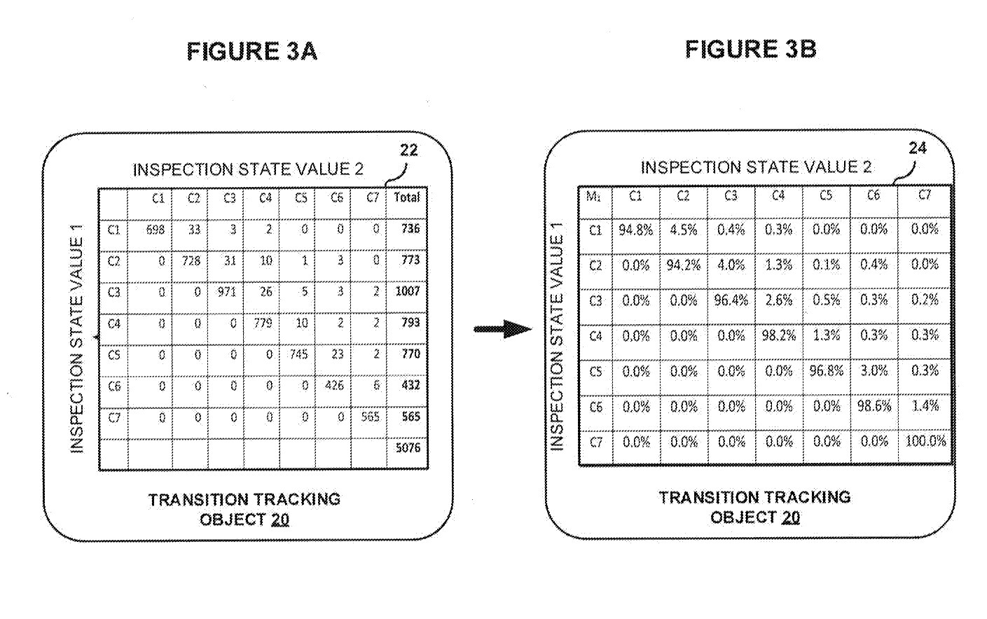

Transition Tracking (TT) Objects 20a, 20b and 20c includes a virtual processing component for extracting said condition state data pairs based on the actual inspection data records 12a, 12b and 12c of respective CIS Objects 10a, 10b and 10c fort he selected time interval 16 accordingly. The TT Objects 20a, 20b and 20c generates the Transition Frequency Matrix 22 by incrementing each condition index value for each occurrence of said condition state data pair. The Transition Tracking Object 20 further includes a second virtual processing component which performs functions to calculate a probability of occurrence of each said condition state data pair. More regarding the exemplary execution of the TT Objects 20a, 20b and 20c is presented later herein with respect to FIGS. 3A and 3B.

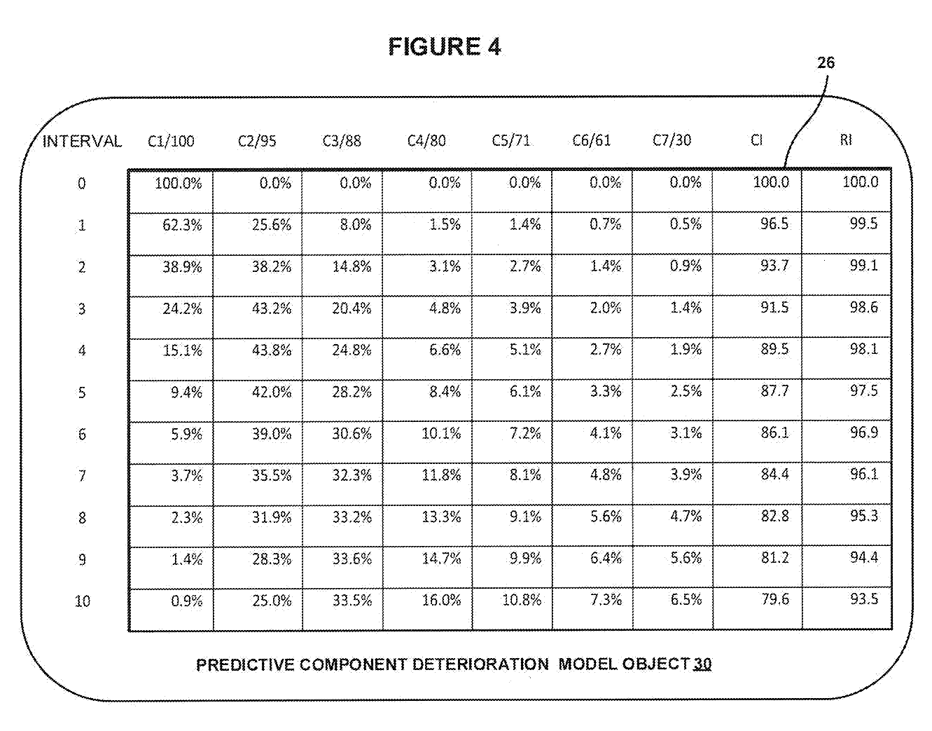

In one embodiment, the System 100 includes a Predictive Component Deterioration Model Class 3 which instantiates a Predictive Component Deterioration Model (PCDM) Object 30. The PCDM Object 30 creates a matrix with a series of time intervals 16 and associates a statistically probable condition index value to predict or progressively model deterioration at said time interval 16. More regarding the exemplary execution of the PCDM Objects 30 is presented later herein with respect to FIG. 4.

It is noted that the formatting and/or arrangement of the aforementioned matrices or cells thereof of CIS Objects 10a, 10b and 10c. TT Objects 20a, 20b and 20c and PCDM Object 30 may vary accordingly. Nonetheless, the underlying data produced and/or presented support the ability of a user to predictively analyze component deterioration per use of System 100. It will be appreciated by those skilled in the art that such functionality readily supports resource planning, budget operations, supply chain optimization (e.g., just-in-time component renewal), service operations, logistics planning, etc.

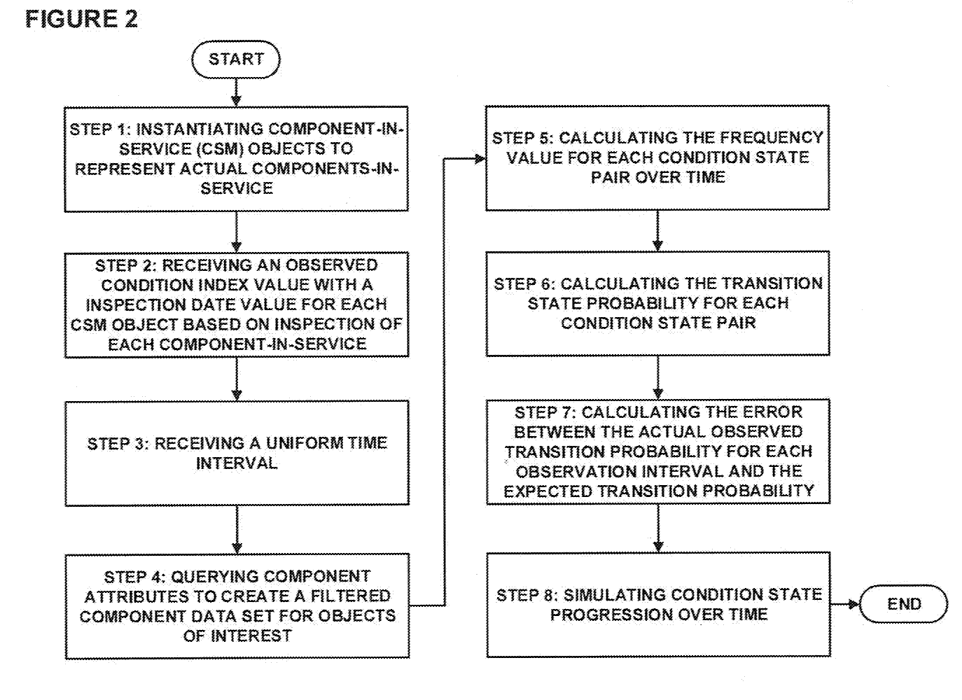

FIG. 2 illustrates an exemplary method for creating a model of predictive deterioration for a component over progressive normalized time intervals. The method is presented for example as one or more steps.

Step 1 is the step of instantiating Component-In-Service (CIS) Objects to represent actual components Component attributes may include, but are not limited to type, age, location, operating environment and degree of maintenance performed. The choice of component attributes for each CIS Object is based on actual observed data about building components in service or may be derived from databases.

Step 2 is the step of receiving an observed condition index value with an inspection date value for each component based on inspection of building components service. An inspection may consist of a visual observation, actual data capture or testing of the actual component. The exemplary embodiment shown uses a condition index value, depicted as a condition index (CI), for indicating a numerical rating. CI values are ranked on a 0-100 ordinary scale, wherein a higher index value represents a favorable physical condition of the component in service while a lower value represents a less favorable condition.

Step 3 is the step receiving a uniform time interval. A uniform time interval is a uniform time interval selected by a user and need not conform to the time of the actual (variable) observation of the component. The exemplary embodiment shown uses a one year uniform time interval to reflect that building component repairs and inspections are typically planned on an annual basis. In other embodiments, alternative conditions may, warrant a different cycle time.

Step 4 is the step of querying component attributes to create a filtered component data set for objects of interest. The filtered component data set may include components selected based on any attributes, including but not limited to component type, and component location, etc., for creating a table of filtered components.

Step 5 is the step of calculating the frequency value for each condition state pair over time. This step is performed by instantiating and updating a Transition Frequency Matrix for each component type to track inspections performed on every instance of the component type. The period reflected by the Transition Frequency Matrix commences on a first inspection date and ends on a last inspection date. The cells within the matrix reflect the number of instances in which a component is observed to transition from a first condition in (S₁), corresponding to a first condition index value, to a second condition state at the last inspection (S₂), corresponding to a second condition index value. S₁ and S₂ are referred to as condition state pairs. The Transition Frequency Matrix tracks the frequency with which each condition state pair occurs and a normalizing function is used to adjust for variable inspection intervals.

The vertical axis of the Transition Frequency Matrix represents every condition state at first inspection and the horizontal axis represents every condition state pair at last inspection so that each cell location is identified by coordinates representing S₁ and S₂. Each cell with within the matrix is incremented each time the System receives inspection date values as input indicating that a specific condition state pair has occurred. The value in each cell, indicating the frequency with which a condition state pair occurs is referred to as the frequency value. Prior to incrementing the frequency value reflected in each cell, a normalizing function is used to adjust for variable (non-uniform) inspection intervals.

Step 6 is the step of calculating the transition state probability for each condition state pair. This calculation is performed by dividing the frequency value for each condition state pair by the number of components having the same condition state at initial inspection. This step is performed by instantiating and updating a characteristic transition matrix.

Step 7 is the step of calculating the error between the actual observed transition probability for each observation interval and the expected transition probability. This step is performed by instantiating and updating the Transition Frequency Matrix. The characteristic matrix adjusts the transition state using a numerical optimization method to minimize the sum of squares error between the observed and expected probabilities for each cell of each matrix. This results in a Transition Frequency Matrix that best fits the observations across all observation intervals.

Step 8 is the step of simulating condition state progression over time. In this step, the probabilities in the Transition Frequency Matrix are used to simulate the probability of each condition state at a general point in time, given a known condition state at a specific point in time. The sum of the probability of each; condition state is multiplied by the representative condition index of each respective state and can be used to calculate the expected condition index at any given time. In addition, the Predictive Deterioration Matrix at any point in time can be calculated as the sum of the probabilities of the acceptable and/or non-failed condition states.

FIGS. 3A and 3B illustrate exemplary processes performed by a Transition Tracking Object using a novel Transition Frequency Matrix. In FIG. 3A, the novel data structure of a Transition Tracking (TT) Object 20 is instantiated for one selected interval 16. As noted previously, the time interval 16 may be selected by a user as a first and second inspection date value corresponding to a first and second condition index value respectively. The TT Object 20 then populates the values of a Transition Frequency Matrix 22 by determining the frequency of component instances that transition from each condition index value observed by the first inspection to the condition index value (e.g., condition index value 5) observed by the subsequent inspection.

As depicted in FIG. 3B, additional processing is, performed by the TT Object 20 based on the determined values of the Transition Frequency Matrix 22. The TT Object 20 calculates transition probabilities for each condition index value pair for each observation interval. The TT Object 20 then populates the values of a Condition Probability Matrix for indicating the conditional probability of transitioning from one condition state to another by dividing each cell of the Transition Frequency Matrix 22 by the row sum the cell is in. Any known means of data computation, statistical analysis or the like may be performed by the TT Object 20 for determining said conditional probabilities to a high level of accuracy.

The TT Object 20 further calculates the error between the actual observed transition probability for each time interval 16 and an expected transition probability based on a characteristic transition matrix (not shown). The characteristic transition matrix probabilities may then be adjusted using a numerical optimization method to minimize the sum of squares error between the observed, as per Condition Probability Matrix 24, and expected probabilities for each cell of each matrix. This results in the characteristic transition matrix that best fits the observations across all observation intervals. As such, the Transition Tracking Object 20 facilitates the continual learning and/or updating of component condition changes over time.

FIG. 4 illustrates an exemplary process performed by a Predictive Component Deterioration Model (PCDM) Object for simulating condition state progression over time. This simulation may be generated by the PCDM Object 30 as a Predictive Deterioration Matrix 26. The PCDM Object 30 invokes functions to simulate the probability of each condition state at a general point in time given a known condition state at a specific point in time. The sum of the probability of each condition state, i.e., corresponding to a condition index value, multiplied by the representative condition index value of each respective state can be used to calculate the expected condition index value at any given time. In addition, if a certain state or states are identified as unacceptable or failure states, the PCDM Object 30 can calculate the reliability index at any point in time as the sum of the probabilities of the acceptable and/or non-failed condition states.

The exemplary functions, processes and executions of the Component-In-Service (CIS) Object 10, Transition Tracking (IT) Object 20 and Predictive Component Deterioration Model (PCDM) Object 30 may be performed independently or interdependently—as one or more virtual processing components per any known computing methodologies—for or modeling component deterioration and predicting an optimal replacement date of a given component. By way of example, the Transition Frequency Matrix 22, Condition Probability Matrix 24 and Predictive Deterioration Matrix 26 generated by the TT Object 20 and PCDM Object 30 respectively may be rendered to a user interface (not shown) associated with said objects. As such, the resulting matrices or select values thereof may be presented entirely or in part to a user via a display device in accordance with any known user interface approaches.

What is claimed is:

1. A predictive modeling system for representing deterioration of a component-in-service comprised of:
a plurality of Component-In-Service Objects, wherein each of said plurality of Component-In-Service Objects represents an actual component-in-service and is associated with one or more inspection data records for said actual components-in-service;
a plurality of Transition Tracking Objects, wherein each of said plurality of Transition Tracking Objects is associated with a single time interval and receive condition state pairs for a plurality of filtered components-in-service wherein said condition state pairs are pairs of condition-index-values which reflect condition states at the be ginning and end of said interval and
a Predictive Component Deterioration Model Object which identifies a plurality of time intervals wherein each of said time intervals identifies one of said plurality of Transition Tracking Objects and is further associated with one of a plurality of predicted condition states.

2. The system of claim 1 wherein each of said plurality of predicted condition states of said Predictive Component Deterioration Model Object is determined by functions performed by one of said plurality of Transition Tracking Objects.

3. The system of claim 1 which further includes a processor to filter each of said plurality of Component-In-Service Objects for attributes of interest to create a subset;of said Component-in-Service Objects having said attributes of interest to create said Predictive Component Deterioration Model Object.

4. The system of claim 1 wherein each of said plurality of Component-In-Service Objects includes an Inspection Data Matrix containing inspection data records and functions to Modify the inspection data records included in said Inspection Data Matrix.

5. The system of claim 4 wherein each of said plurality of inspection data records is comprised of an inspection date value and a condition index value.

6. The system of claim 1 wherein each of said plurality of Transition Tracking Objects further includes a processor to calculate transition state probability values to reflect the probability that one or more of said condition state pairs will occur.

7. The system of claim wherein each of said plurality of Transition Tracking Objects includes a Transition Frequency Matrix data structure which stores a frequency of occurrence of each of said plurality of condition state pairs.

8. The system of claim 7 wherein said Transition Frequency Matrix stores a plurality of condition state pairs which correspond to a single time interval, wherein said time interval is comprised of a first inspection date and a second inspection data.

9. The system of claim 7 wherein aid Transition Frequency Matrix further includes a plurality of cells, wherein the location of each cell within said Transition Frequency Matrix corresponds a condition index value for said first inspection date and a condition index value for said second inspection date.

10. The system of claim 1 which receives input comprised of a first inspection date and a second inspection date to determine a normalized time interval.

11. The system of claim 10 which instantiates Transition Tracking Objects associated with a time interval corresponding to said normalized time interval.

12. The system of claim 10 wherein said normalized time interval is selected from a group consisting of an hour, day, month, or a specified number of the foregoing,

13. The system of claim 1 wherein each of said plurality of Components-In-Service Objects include attributes selected from a group consisting of a component type, age, location, operating environment and degree of maintenance.

14. The system of claim 1 wherein, each of said plurality of Transition Tracking Objects further includes a processor which iteratively receives condition state pairs as input and performs a function to increment a cell of a Transition Frequency Matrix corresponding to the occurrence of each of said plurality of condition state pairs.

15. The system of claim 14 wherein said processor of said plurality of Transition Tracking Objects further calculates an error between an observed and expected probability that one or more of said condition state pairs will occur for each cell.

16. A predictive model computer apparatus, which comprises:
at least one microprocessor;
a plurality of Component-In-Service Objects, wherein each of said plurality of Component-In-Service Objects represents a plurality of actual components-in-service and is associated with one or more inspection data records for said actual components-in-service;
a plurality of Transition Tracking Objects, wherein each of said plurality of Transition Tracking Objects corresponds to at least one time interval and includes a Transition Frequency Matrix which receives condition state pairs for a plurality of filtered components-in-service wherein said condition state pairs are pairs of condition index values reflecting condition states at the beginning and end of aid interval; and
a Predictive Component Deterioration Model Object which identifies a plurality of time intervals each of which is associated with one of a plurality of predicted condition states.

17. The predictive model apparatus of claim 16 which further includes an interface for receiving a plurality of inspection data records for each of said plurality of actual components-in-service and storing said plurality of inspection data records in each of said plurality of Component-in-Service Objects.

18. A method for creating virtual processing components to predictively model deterioration of individual building components, comprised of performing the steps of:
instantiating Component-In-Service Objects to represent components-in-service having attributes, wherein said Component-In-Service Objects further perform the steps of receiving a condition state for each inspection date on which each component-in-service was inspected;
instantiating a plurality of Transition Tracking Objects, wherein each of said plurality of Transition Tracking Objects corresponds to at least one time interval and includes Transition Frequency Matrix:
receiving condition state pairs for plurality of filtered components-in-service wherein said condition state pairs are pairs of condition index values reflecting condition states at the beginning and end of aid t least one time interval;
incrementing a frequency value or each of said plurality of condition state pairs for each of said plurality of filtered components-in-service;
calculating a probability percentage that each of said plurality of condition state pairs will occur; and
instantiating a Predictive Component Deterioration Model Object, wherein said Predictive Component Deterioration Model Object populates a plurality of time intervals each of which is associated with one of a plurality of predicted condition states corresponding to said probability percentage.

19. The method of claim 1 wherein each of said plurality of Transition Tracking Objects further performs the step of multiplying said probability percentage by a failed condition state to obtain each of said plurality of predicted condition states.

20. The method of claim 1 wherein each of said plurality of Transition Tracking Objects further performs the step of squaring the difference between each of said plurality of predicted condition states and said frequency value to obtain an error value.
